(19) United States
(12) Patent Application Publication
(10) Pub. No.: US 2009/0120882 A1
(43) Pub. Date: May 14, 2009

(54) Device for Treating Fluids, Especially Water Sterilization, Comprising an Electrodeless Gas Discharge Lamp

(75) Inventors: Alex Voronov, Hanau (DE); Silke Reber, Gelnhausen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HERAEUS NOBLELIGHT GMBH, Hanau (DE)

(21) Appl. No.: 12/300,231

(22) PCT Filed: May 3, 2001
(86) PCT No.: PCT/EP07/03912

§ 371 Date: Nov. 10, 2008

(30) Foreign Application Priority Data
May 10, 2006 (DE) 10 2006 022 004.8

(51) Int. Cl. C02F 1/32; H01J 61/52

(52) U.S. Cl. 210/748; 313/35

(57) ABSTRACT

A fluid treatment plant, particularly a water disinfection plant, having more efficient energy utilization and increased service life in discontinuous operation, is producible as a simple mass-production product, that can be handled easily and is particularly suitable for household use. UV emitters are avoided that are complicated or that cannot be operated without danger, such as DBD lamps with coaxial tubes, as well as complicated ballast devices, and dangerous electrical constructions. Fluid raw materials are converted with UV radiation into qualitatively superior or novel products, in that a fluid to be treated is brought into contact with the emitter, so that the fluid is irradiated with UV radiation and has a direct influence on the temperature of the emitter, in particular it sets the operating temperature of the emitter between 0° C. and 30° C. For this purpose, simple UV emitters are used, in which an excimer filling is excited without electrodes in a UV-transparent discharge vessel, particularly a quartz glass tube.

### CROSS-REFERENCE TO RELATED APPLICATIONS

This application is a Section 371 of International Application No. PCT/EP2007/003912, filed May 3, 2007, which was published in the German language on Nov. 15, 2007, under International Publication No. WO 2007/128494 A1, and the disclosure of which is incorporated herein by reference.

### BACKGROUND OF THE INVENTION

The invention relates to plants for treating fluids, particularly water, in which the fluid is treated, particularly disinfected, with UV radiation. The invention also relates to a method for treating fluids, arrangements of electrode-less gas-discharge lamps suitable for this method, and the use of UV light sources in air preparation plants.

In this respect, there are already water disinfection plants in which the water is irradiated with a mercury discharge lamp. Mercury discharge lamps have high efficiency and are therefore suitable especially for large-scale plants, where they can be used in continuous operation. Mercury discharge lamps can be easily produced in mass production from a UV transparent tube, particularly quartz glass, electrodes, and a discharge filling. For the preparation of water for individual households, continuous operation is not cost-effective. Since mercury lamps necessarily run through a five-minute startup phase until they output their full power, a discontinuous operation is also less attractive for an individual household. In addition, there is the continuous risk of danger due to the mercury.

European Patent EP 1 345 631 B1 discloses an arrangement suitable for continuous operation of a mercury UV lamp, which is excited with microwaves from a magnetron and whose lamp body is in contact with a fluid on one side. On the other side of the lamp body there is a funnel that conducts the microwaves from the magnetron out of the lamp body.

Low-pressure mercury lamps that achieve an efficiency of up to 35% require for this, however, an operating temperature between 30° C. and 50° C. For cool fluid flows, particularly in water supply or air preparation systems, the mercury discharge lamps are cooled greatly by the flows, so that they cannot develop their fall UV power. Therefore, for cooling fluid flows, mercury lamps are used with an additional jacket tube.

### BRIEF SUMMARY OF THE INVENTION

It is an object of the present invention to make the energy utilization more efficient for discontinuous operation and to increase the service life of the system. Another object of the present invention is to provide a simply mass-producible product, that is easily handled, and that is particularly suitable for households. UV emitters with complicated operation or not operable without danger, such as Hg-filled lamps or dielectric barrier discharge (DBD) lamps with coaxial tubes, lamps with expensive ballast devices, and dangerous electrical constructions, should be avoided.

According to an embodiment of the invention, mercury-free gas-discharge lamps are provided with excimer fillings, wherein these lamps can be operated efficiently at temperatures between 0° C. and 30° C., in contrast to mercury low-pressure discharge lamps, and thus the service life of the lamp body can be lengthened considerably. Optimum cooling is thereby achieved, in that the lamp body projects far into the irradiated fluid by which it is cooled.

In this way, fluid raw materials are converted with UV radiation into qualitatively superior or novel products, in that a fluid to be treated is brought into contact with the lamp body, in that the fluid is irradiated with UV radiation from the lamp body, and in that the fluid directly influences the temperature of the lamp body, and in particular sets the operating temperature of the lamp body jacket tube between 0° C. and 30° C. For this purpose, simple UV lamps are used in which an excimer filling is excited without electrodes in a UV-transparent discharge vessel, particularly a quartz glass.

One embodiment of the invention is an arrangement of an electrode-less gas-discharge lamp in a fluid irradiated by the lamp and that directly influences the temperature of the lamp body, particularly its jacket tube, which comprises having the lamp body project far into the fluid, particularly with at least 80% of its surface area, preferably 90%, of its surface area. For this purpose, the lamp body is preferably constructed as a tube whose longitudinal axis is arranged in the propagation direction of the microwaves.

Another embodiment of the invention is an arrangement of an electrode-less gas-discharge lamp with an excimer filling that projects far into a fluid irradiated by the lamp and that directly influences the temperature of the lamp body, particularly its jacket tube. This allows the cooling of the lamp body and thus lengthens its service life. In order to cool its surface as much as possible with the fluid, a lamp tube projects with over 80%, particularly over 90%, of its surface area into the fluid when the lamp body is mounted on the end on a microwave supply. The longitudinal axis of the lamp body is then arranged parallel to the propagation of the microwaves.

Excimer fillings are mercury-free mixtures of noble gases with halides and are therefore less dangerous than fillings containing mercury. Second, the excimer fillings can and should be operated at lower temperatures than lamps containing mercury, particularly between 0° C. and 30° C. Third, with a lower temperature operation of the excimer lamps, their service life can be prolonged. For this purpose, preferably at least 80% of the surface area of the lamp body is cooled by fluid. For this purpose, it has proven effective to have the lamp tube extend far into the fluid medium.

A further embodiment of the invention is a discontinuous method for the treatment, particularly disinfection, of fluids in a fluid treatment plant, particularly a water disinfection plant, in which UV radiation is used, wherein a fluid is brought into contact with an electrode-less gas-discharge emitter in the plant, so that the fluid is irradiated with UV radiation by the emitter and the fluid directly influences the temperature of the emitter, particularly its jacket tube. Here, for prolonging its service life, the lamp body is cooled efficiently by the irradiated fluid, if it projects far into the fluid. Discontinuous methods typically have operating times in the range of seconds or minutes.

Another embodiment of the invention is a fluid treatment plant, particularly a water disinfection plant, for the treatment of fluids, particularly for their disinfection, in which UV radiation is used, wherein the plant has an electrode-less gas-discharge lamp in a fluid irradiated by the lamp and that directly influences the temperature of the emitter, particularly its jacket tube. Here, for its cooling and thus prolonged service life, the lamp body extends far into the fluid.

In one preferred embodiment, the filling is located in a simple quartz-glass tube. This embodiment of the present invention allows mercury-free emitter constructions, particularly based on a xenon-bromine filling or a krypton-chlorine filling or a xenon-iodine filling or a krypton-fluorine filling.

According to the invention, the UV emitter is operated without electrodes. For this purpose, the excitation of an excimer gas-discharge lamp by microwaves has proven effective. Microwaves can be generated in a magnetron and can be fed to the excitation lamp via a waveguide. Surprisingly, compared to a conventional UV lamp operated with a magnetron according to www.muegge.de, the additional jacket tube and also the metal rod in the lamp can be eliminated as well as the additional shielding cage around the UV lamp according to a Simon-Hartley reactor.

In an inventive improvement, the lamp is no longer operated with a separate coolant, but instead is directly cooled by the fluid to be treated. Consequently, the lamp is surrounded by only one fluid, instead of two fluids. The conductivity of the fluid plays no role, in contrast to U.S. Patent Application Publication No. 2002/089275. The UV lamp used according to the invention also functions with absolutely non-conductive fluids.

For water disinfection UV emitters are used that are operated with magnetrons. Here, the magnetrons are used as generators for creation of microwaves. With the microwaves generated in the magnetron, a discharge gas is excited in a discharge vessel, particularly a quartz glass tube. For such UV emitters electrode-free discharge vessels are used with an excimer filling, particularly with a xenon-bromine filling or a krypton-chlorine filling or a xenon-iodine filling or a krypton-fluorine filling. These emitters do have a lower efficiency relative to mercury lamps, but are distinguished by a practically non-existent startup time and are therefore suitable for discontinuous operation in small water preparation plants for individual households.

Another embodiment of the invention includes the use of UV light sources, such as discharge lamps, for irradiating air that directly influences the temperature of the UV light source.

In the sense of the present invention, the treatment of fluids is not to be understood as the mere cooling, but instead as the treatment of raw material into a processed product, for example the preparation of water or air, particularly in wastewater or freshwater treatment plants, as well as in flue gas or fresh air treatment plants. The simple handling and the simple production of the plants according to the invention are a great advantage for domestic applications, particularly domestic water supply. The treatment of fluids according to the invention can also be used advantageously, for example, for air-conditioning systems or the air supply in buildings or trains, and the production of vitamin D, as well as industrial uses.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, cross-sectional side view of an emitter arranged in a fluid flow according to an embodiment of the invention; and

FIG. 2 are plots of spectra of a low-pressure emitter according to an embodiment of the invention and the DNA absorption curve of Escherichia coli.

### DETAILED DESCRIPTION OF THE INVENTION

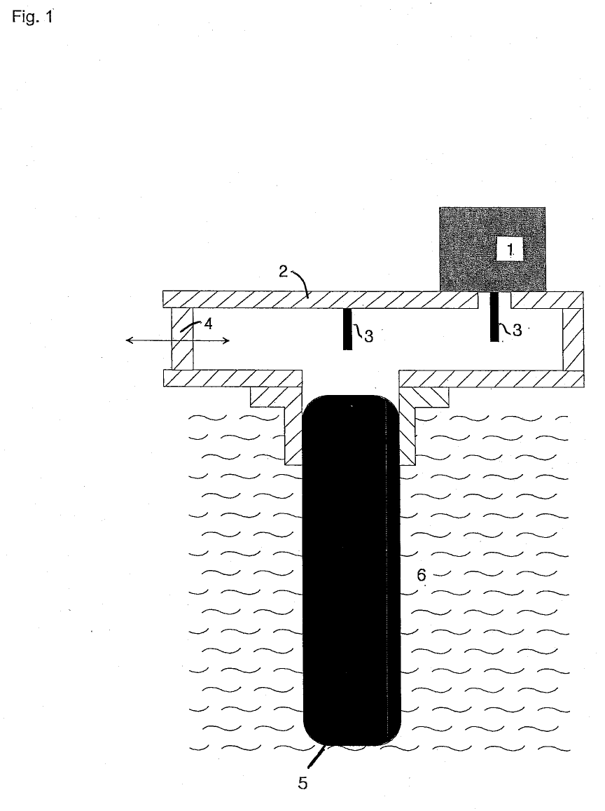

In a cold-operation excimer emitter according to FIG. 1, around which water to be disinfected flows, the water to be treated directly cools the disinfection lamp. Lamps with an excimer gas filling for cold operation, for example mercury-free lamps based on noble gas-halogen mixtures, for example xenon-bromine, krypton-chlorine, xenon-iodine, or krypton-fluorine fillings, are suitable as disinfection lamps. The lamps just named have an optimum operating temperature in the range between 0° C. and 50° C., particularly between 5° C. and 30° C.

In FIG. 1, an electrode-less UV lamp body 5 is immersed in a fluid 6 in a channel provided for the fluid. The electrode-less lamp contains a xenon-bromine gas filling, which can be excited for excimer discharge. The excitation is realized by microwaves that are transmitted by a magnetron 1 via a waveguide 2. In the waveguide 2 standing waves are generated. For this purpose, the waveguide is adjusted with a valve 4. The coupling of the energy from the magnetron into the waveguide and out of the waveguide into the emitter is realized by means of coupling pins 3.

As the magnetron 1, in principle, all generators for creating microwaves can be used.

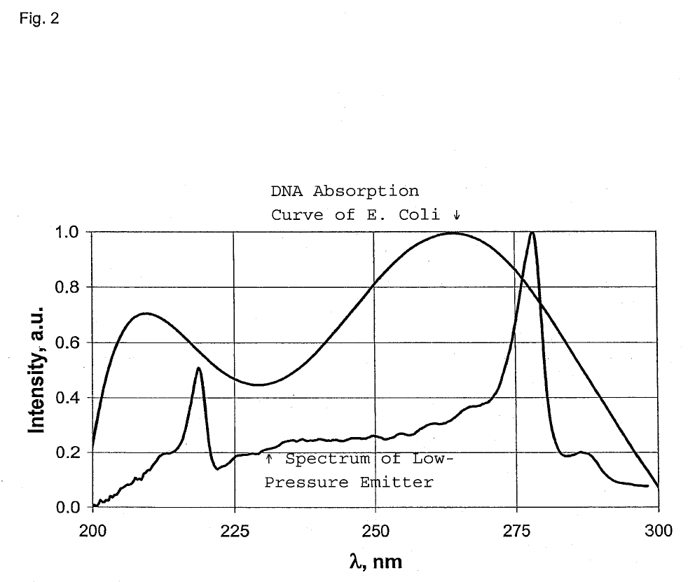

The waveguide 2 is a waveguide that is typical for microwave technology, in which standing waves can be formed. An adjustment valve 4 is used for adjusting the standing waves. Coupling pins 3 allow the coupling of energy from the magnetron into the waveguide and from the waveguide into the emitter. The emitter, excited with microwaves in this way, can be operated directly in water. The spectrum of a low-pressure emitter with xenon-bromine filling is shown in FIG. 2 next to a DNA absorption curve of E. Coli. The similar spectral profile signifies the good suitability of the low-pressure emitter with xenon-bromine filling for disinfection or decontamination.

In this arrangement, microwaves with a frequency of 2.45 GHz or a wavelength of 12.2 cm in a channel carrying a water flow can operate an excimer emitter with a xenon-bromine filling for 1000 hours discontinuously, which corresponds to a service life of a good 3 years in a five-person household. In contrast, the service life of continuous-operation mercury low-pressure lamps with an operating period of 5000 hours has a service life of 6 months, because in continuous operation the service life corresponds to the operating time. Accordingly, in continuous operation the final consumed energy is higher despite better efficiency of the mercury halogen emitter, due to the operating time that is higher by a multiple in continuous operation.

An energy balance in comparison with a mercury low-pressure lamp is illustrated as follows:

In continuous operation a 50 W mercury lamp consumes 1200 Wh every day. At an efficiency of 30%, a 50 W lamp has a radiation output of 15 W. This radiation output is created with a 200 W electrode-less excimer lamp having a bromine-xenon filling. For an operating period of one hour every day in discontinuous operation, this lamp consumes merely 200 Wh a day.

In continuous operation, the service life of a mercury lamp is equal to the running time and equals approximately 6 months. In discontinuous operation, the running time is increased by a multiple relative to the operating time. For an operating time of only 1.5 to 2 months, the running time equals 3 to 4 years for discontinuous operation with an average of one hour per day.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-14. (canceled)

15. An apparatus comprising an electrode-less mercury-free gas-discharge lamp having a lamp body (5) and a fluid (6) to be irradiated by the lamp, wherein the lamp body is arranged in the fluid and the fluid directly influences a temperature of the lamp body.

16. The apparatus according to claim 15, wherein the lamp generates microwaves and the lamp body has a longitudinal axis arranged in a propagation direction of the microwaves.

17. The apparatus according to claim 15, wherein the lamp body has an outer surface area and more than 80% of the surface area of the lamp body projects into the fluid to be irradiated.

18. The apparatus according to claim 17, wherein more than 90% of the surface area of the lamp body projects into the fluid to be irradiated

19. A discontinuous method for treating a fluid in a fluid treatment plant, the method comprising bringing a fluid (6) into contact with a lamp body (5) of an electrode-less gas-discharge lamp in the plant, and irradiating the fluid (6) with UV radiation emitted from the lamp body (5), wherein the fluid (6) directly influences a temperature of the lamp body (5), and wherein an operating temperature of the lamp body is set between 0° C. and 30° C.

20. The discontinuous method according to claim 19, wherein the method comprises disinfecting water in a water disinfection plant.

21. The discontinuous method according to claim 19, wherein the lamp body is arranged with its longitudinal axis in a propagation direction of microwaves of the UV radiation.

22. The discontinuous method according to claim 19, wherein more than 80% of a surface area of the lamp body projects into the fluid to be irradiated.

23. A fluid treatment plant comprising an electrode-less gas-discharge lamp which emits UV radiation, the lamp having a lamp body (5) arranged in a fluid (6) to be irradiated by the lamp (5), wherein the lamp body is filled with a mercury-free excimer gas mixture, wherein more than 80% of a surface area of the lamp body projects into the fluid to be irradiated, and wherein the fluid (6) directly influences a temperature of the lamp body (5).

24. The fluid treatment plant according to claim 23, wherein the plant is a water disinfection plant for disinfection of water.

25. The fluid treatment plant according to claim 23, wherein the lamp body is filled with filling selected from xenon-bromine, krypton-chlorine, xenon-iodine, and krypton-fluorine fillings.

26. The fluid treatment plant according to claim 23, wherein the lamp body comprises a simple quartz tube filled with the excimer gas mixture.

27. The fluid treatment plant according to one of claim 23, wherein the lamp is excited with microwaves.

28. An air preparation plant comprising a UV lamp arranged in air to be irradiated by the UV lamp, wherein the air to be irradiated by the UV lamp directly influences a temperature of the UV lamp.

29. The air preparation plant according to claim 28, wherein the UV lamp is cooled by the irradiated air.

30. The air preparation plant according to claim 28, wherein more than 80% of a surface area of the UV lamp projects into the air to be irradiated.

31. The air preparation plant according to one of claim 28, wherein the UV lamp is free of mercury.

32. The air preparation plant according to claim 28, wherein the UV lamp is an electrode-less gas-discharge lamp.
